(19) United States
(12) Patent Application Publication
(10) Pub. No.: US 2016/0261647 A1
(43) Pub. Date: Sep. 8, 2016

(54) METHOD, SYSTEM AND APPARATUS FOR INVITING USERS TO PARTICIPATE IN AN INTERACTIVE SESSION

(71) Applicant: Calay Venture S.à r.l., Bettembourg (LU)

(72) Inventor: Cevat Yerli, Frankfurt am Main (DE)

(21) Appl. No.: 14/635,714

(22) Filed: Mar. 2, 2015

(51) Int. Cl. H04L 29/06; H04L 12/58

(52) U.S. Cl. CPC H04L 65/1069; H04L 65/4053; H04L 65/4015; H04L 65/4069; H04L 51/32

(57) ABSTRACT

A method for inviting users to participate in an interactive session comprises receiving a request, from a client device, wherein the request specifies information regarding one or more invitees, creating a link from the information regarding one or more invitees, providing the link to the one or more invitees, and in response to an invitee activating the link, establishing a connection to the interactive session and enabling said invitee to participate in said interactive session. Furthermore, a system for inviting users to participate in interactive sessions and a link server device are disclosed.

### TECHNICAL FIELD

The present disclosure relates to a method, system and apparatus for inviting users to participate in an interactive session, such as an online game or a video presentation.

### BACKGROUND

Interactive sessions, such as online games or video presentations, may allow multiple users to participate. For example, a user or host involved in a computer-based activity can invite other users or guests to participate in the interactive session. However, prior art techniques require that invitees are specified by the inviting person, and hence need to be known beforehand.

Further, inviting users according to prior art techniques involves complicated measures, including specifying one or more invitees by an inviting person, as well as requiring an invitee to launch a client application in order to join the interactive session.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A first aspect of the disclosure is a method for inviting users to participate in an interactive session, comprising: receiving a request from a first client device at a second client device, said request specifying information regarding one or more invitees; creating a link from said information regarding said one or more invitees; providing the link to said one or more invitees; and in response to an invitee activating the link, establishing a connection to the interactive session in its present state and enabling said invitee to participate in said interactive session.

According to one embodiment, the request may further include information regarding a present state of the interactive session, wherein creating a link may further include using said information regarding a present state of the interactive session to provide details of the present state in the link when viewed by a user.

A second embodiment of the first aspect includes providing the interactive session within a social network that the one or more invitees are not a member of.

According to a third embodiment, creating the link includes determining the one or more invitees from the information regarding the one or more invitees, wherein the information includes attributes to be satisfied by users in order to be invited.

A further embodiment of the first aspect includes providing the link to said one or more invitees through email, SMS, a social network site, a website, or a forum.

A fifth embodiment of the first aspect comprises creating and providing the link by a link server.

According to a further embodiment, the interactive session is an interactive multiplayer game.

A seventh embodiment comprises the interactive session providing streaming media, in particular streaming audio and/or streaming video.

According to another embodiment, the interactive session comprises one or more slots for participants that limit the number of participants.

In a further embodiment, enabling an invitee to participate in the interactive session further comprises providing access to additional functionality provided by a provider of the interactive session.

A tenth embodiment of the first aspect includes that the interactive session is provided from within a social network and that enabling an invitee to participate in the interactive session includes enabling the invitee to access functionality of the social network that is available to members of the social network only.

A further embodiment comprises creating a guest account for each of the one or more invitees in response to the invitee selecting the link.

A second aspect of the present disclosure comprises a computer-readable medium storing instructions which, when executed by a processor, perform the method according to any one of the aforementioned embodiments. The non-transitory computer-readable medium has instructions stored thereon, wherein said instructions, in response to execution by a computing device, cause said computing device to automatically perform a method for inviting users to participate in an interactive session according to one or more embodiments of the present disclosure. In particular, the computing device may be configured by the instructions to receive a request from a client device, said request specifying information regarding one or more invitees, creating a link from said information regarding one or more invitees, providing the link to said one or more invitees, and in response to an invitee activating the link, establishing a connection to the interactive session and enabling said invitee to participate in said interactive session.

According to a third aspect, a system is provided for inviting users to participate in an interactive session, said system comprising: a first server providing an interactive session and adapted to create a request for a link into said interactive session; and a second server adapted to receive the request along with information regarding one or more invitees, and further adapted to create the link from said information regarding one or more invitees, and to provide the link to said one or more invitees connected to the second server via a network; wherein the second server is further adapted to establish a connection to the interactive session and to enable an invitee to participate in the interactive session in response to the invitee activating the link.

A first embodiment of the third aspect includes that the first server is a social network server and that the one or more invitees are not a member of a social network provided by the social network server.

According to a second embodiment, the second server is further adapted to provide the link through email, SMS, a social network site, a website, or a forum.

A third embodiment of the third aspect includes that the interactive session is an interactive multiplayer game.

According to a further embodiment, the interactive session provides streaming media, in particular streaming audio and/or streaming video.

According to a fifth embodiment of the third aspect, the interactive session comprises one or more slots for participants that limit the number of participants.

A fourth aspect of the present disclosure is a link server, comprising: first means adapted to receive a request along with information regarding one or more invitees for an interactive session; second means adapted to create a link from said information regarding one or more invitees and to provide the link to said one or more invitees connected to the link server via a network; and third means adapted to establish a connection to the interactive session and to enable an invitee to participate in the interactive session in response to the invitee activating the link.

Aspects of the disclosure advantageously accomplish inviting users to an interactive session without requiring the invitees to be known to the inviting entity at the time of the invitation. This is inventively achieved by creating an invitation link based on information provided by the inviting entity, but independent of any specific persons the inviting entity may be aware of.

### BRIEF DESCRIPTION OF THE DRAWINGS

FIG. 1 is a flow diagram of a process in accordance with an aspect of the present disclosure;

FIG. 2 is a block diagram of a first system according to aspects of the present disclosure; and

FIG. 3 is a block diagram illustrating a second system according to aspects of the present disclosure.

### DETAILED DESCRIPTION

The present disclosure describes methods, apparatuses and systems enabling users or technical entities to invite guests to join an interactive session. An interactive session may be joined asynchronously or synchronously, wherein asynchronous participation refers to a single user taking part in the interactive session, whereas synchronous participation refers to multiple users taking part. Examples of interactive sessions include multi-player or single-player games, as well as streaming audio or video sessions. All of these may provide synchronous or asynchronous participation. Interactive sessions may as well include elements of a company or product brand, or may represent animated advertisements themselves. Very briefly, the disclosed embodiments automatically create a link upon request, said link effective to establish a connection into an interactive session upon activation of the link by a user. Advantages of these embodiments include inviting users or technical entities which may not be known to the inviting entity at the time of the invitation. A further advantage is that the connection to and participation in the interactive session may be achieved by a single click of the link, once the link is provided. This makes it very convenient both for inviting and invited entities to meet in a same interactive session.

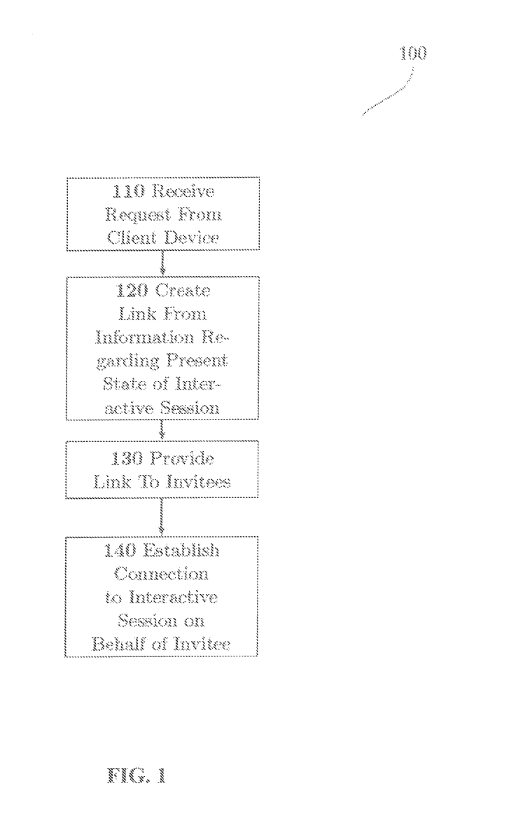

FIG. 1 illustrates a method for inviting users to participate in an interactive session. In a first step, depicted as step 110, a request may be received, e.g., from a client device. The request may be issued to create an invitation link. The request may be issued manually by a user. It may alternatively be issued by a technical entity, such as by a program configured to automatically request invitation links at certain times or under certain conditions. Issuing the request may involve transmitting a request from a requesting location, such as a computing device, to a target location that is to create the invitation link, such as a server. Issuing the request may include providing information regarding one or more invitees. This information may comprise addresses of invitees, such as email addresses. Alternatively, the request may not specify invitees by addresses but may provide information which requires technical analysis in order to identify one or more invitees. For example, the information may include properties to be satisfied by potential invitees. The request may further include information regarding an interactive session the invitees are to be invited to. Examples of interactive sessions include an online muli-player game or a streaming video session. The information regarding the interactive session may include technical details on establishing a connection to said session, such as an Internet Protocol (IP) address and/or access credentials, such as a username and password. According to a specific embodiment, the information regarding the interactive session may further include details on the present state of the interactive session, such as a number of players or viewers already participating in the interactive session, or such as a level reached in a game, or a scene reached in a film. The request is received at a further entity, such as a link server.

In step 120, a link may be created based on the request and its accompanying information. In one embodiment, the link may be a Uniform Resource Locator (URL) to be embedded in a website or in any other hypertext content, including an email. Creating the link may include specifying one or more invitees based on information provided in the request, such as properties to be satisfied by users in order to qualify as an invitee. In one embodiment, the request may specify that invitees should have previously participated in an interactive session similar or identical to the present interactive session. In the case of a video session, users may be invited who watched a similar video before. In the case of a multiplayer game, users may be invited who played the same or a similar game before, or who played the same game and reached a particular level in the game. In some embodiments, the request includes information regarding a present state of the interactive session, which may be used at a link server to evaluate properties when identifying invitees. As an example, the link server needs to know a present game level in order to determine users which have previously reached that level. Specifying users may also involve creating an intersection of users who satisfy any of the aforementioned conditions and who satisfy a further condition, such as being connected to the Internet at present or being likely to be connected to the Internet at present. The request may include any set of properties to be satisfied by users in order to be invited. Properties may be specified as a logical expression by an inviting entity.

Determining users to be invited may involve analyzing user data, such as user data available at a social network. However, in one embodiment, only non-members of a social network may be determined. For example, the interactive session may be provided from within a social network, and users who are not a member of the social network shall be enabled to participate in the interactive session. In this embodiment, databases other than databases of a social network running the interactive session may have to be analyzed for potential invitees. Determining users to be invited may include restricting the number of invitees to a predetermined number. Such a number may be provided by the request or may be determined automatically. As mentioned before, the link may be provided for users who satisfy properties provided in the request. Because more users may satisfy the properties than are admissible, only the highest ranking users may be identified as recipients of the link, such as all users reaching a predefined threshold regarding fulfillment of properties.

Creating the link may further include preparing the link with a target address, such as an HTTP link. This address may be configured to establish direct contact to the interactive session if the address is invoked. In one embodiment, establishing contact may only work for any of the one or more invitees mentioned above. For example, a username and password may be created for each of the one or more invitees when creating the link, and may be included in the link itself. Alternatively, a random number may be generated for each invitee, said random number provided in the link. Upon activation, the link will lead an invitee directly into the interactive session, based on authentications via a username and password or via the random number.

Subsequently, the link is provided to each of the one or more invitees in step 130. Providing the link may include embedding the link on a website currently viewed by a respective invitee, such as a private website of the invitee on a social network. Alternatively, the link may be delivered by email or as an SMS message. It may also be embedded in a forum or message board in the World Wide Web (WWW). In one embodiment, the link may be embedded in any public or private website, wherein the link is only embedded in this website if the visitor is identical to one of the invitees. The skilled person is aware that visitors may be identified at the time they request a website, using an origin address of the request or cookies. At this stage, the website may be dynamically provided with the link if the visitor is identical to one of the invitees.

The aforementioned steps 120 and/or 130 may be performed by a dedicated link server, such as the link server discussed further below. In one embodiment, the link server may be separate from the place of origin of the request. For example, the request could be made by a user at a first client device, whereas the link server is in a different location. In an alternative embodiment, the functionality of receiving a request, as well as creating and delivering a link, may be performed by the same client device was used to provide the request.

Step 140 comprises establishing a connection of an invitee to the interactive session. The address of the interactive session was already specified in the link itself. Accordingly, activating the link will take the invitee to the interactive session. In one embodiment, activating the link will authenticate the invitee based on the username and password or random number in the link. Subsequently, the interactive session may be displayed to the invitee, such as in his local web browser, and the invitee will be admitted to interact with the session.

In one embodiment, the interactive session may include slots for participants. One slot may be assigned to each user participating in the game. Accordingly, access to the interactive session may be denied, even to an invited person, if all slots are occupied. In addition to providing access to the interactive session, the disclosure may include providing access to further functionality, such as functionality provided by a social network to its members but not to non-members, wherein the social network hosts the interactive session. Access to such functionality may include all functionality the social network provides, such as writing messages to other members. In one embodiment, providing access to such functionality may be accomplished by automatically creating a guest account for the invitee in response to the invitee accessing the interactive session.

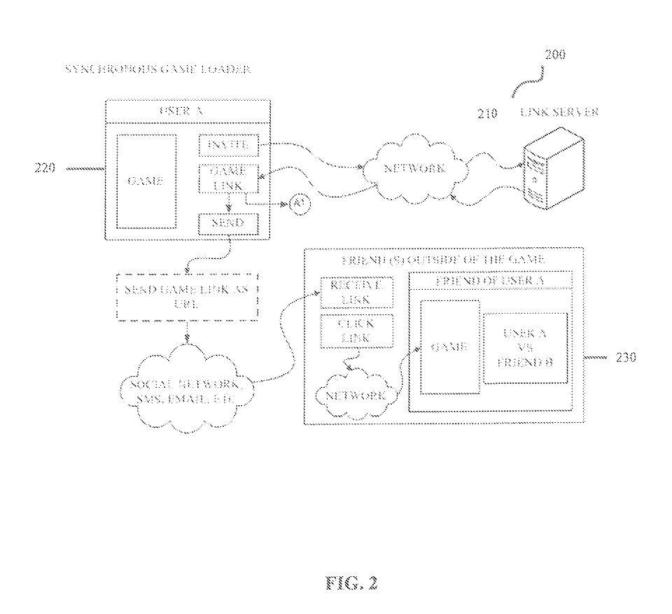

FIG. 2 illustrates a system 200 according to embodiments of the present disclosure. At a client device 220, a request is made by a user, also referred to as the inviter. The request may be sent over the Internet, a Wi-Fi network, or any other suitable network connection to a link server 210. The link server uses information transmitted with the request from the client device to create, set up and configure the link, such as a URL. The link is adapted to allow an invited person to directly join the interactive session through a single click by the steps outlined above with regard to method 100. In addition to the information included in the request as outlined above, the request may also include sender information, challenge information (who, where, when, etc.), and/or game configuration information (game, level, score, mode, content, position, etc.).

In one embodiment, the interactive session may be an advertisement, wherein viewing the advertisement (by participating in the interactive session) could be rewarded with incentives. For example, points could be provided to an invitee upon participating in the interactive session. In one embodiment, the points could immediately be used by the invitee in order to use a certain function provided within the interactive session or within an environment providing the interactive session, including a social network. The amount of points provided to a particular invitee may be determined by the link server at the time of creating the link, and may in one embodiment depend on the degree of the respective invitee satisfying properties defined in the request for identifying one or more invitees.

Once the link has been created and configured by the link server 210, it is sent to the one or more invitees, such as by embedding it in a website as outlined above. Alternatively, the link may be sent back to the client device 220. In this case, the client device 220 provides the link to the invited persons. In one embodiment, the link may be provided by embedding it in a website delivered to invitees. Alternatively, the link can be transmitted over a social network, through SMS, email or any other suitable communication medium that provides for sharing and/or connections to be made. If the interactive session is open to anyone, the link could be embedded in a website or social network according to any of the embodiments provided throughout this disclosure. On receiving the link, the invitee can activate the link URL, such as by clicking it, and is then taken directly into the interactive session. This obviates all of the steps that are normally necessary for joining an interactive session.

One embodiment illustrated by FIG. 2 includes a user A at a client device 220 who has recently played a game and achieved a certain score, such as a score of 5000 points. User A requests a link from link server 210 in order to invite further players to the game. The request may specifically include an address of user B, said address provided by user A. The link server 210 receives the request and creates, sets up and configures the requested link. Subsequently, link server 210 sends the link over the Internet to the client device 220. The client device 220 then sends the link to user B by any means or steps mentioned above or below. User B is hence enabled to join the game by activating the link at any desired time.

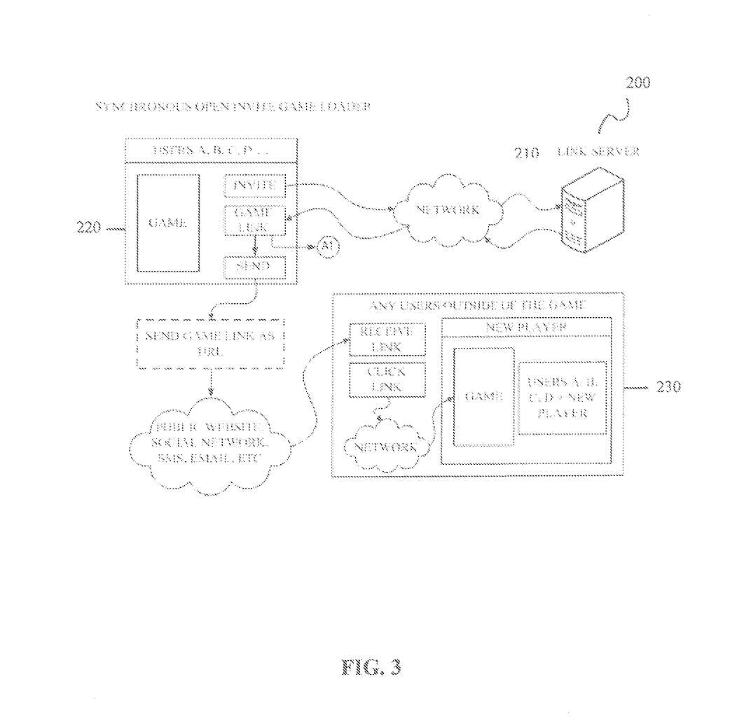

Another embodiment illustrated by FIG. 3 comprises one or more users A, B, C and/or D participating in a single multiplayer game at one or more client devices 220, such as one or more client devices connected with one another via a network. All of these users or any one of them request a link from link server 210 in order to invite further participants. Invitees may be specified in the request by specific address and/or by a logical expression including properties to be satisfied. For example, a property could specify any user who has participated in the same game within a predetermined time period, such as within the last N days. Alternatively or in combination, invitees must have reached at least a present state of the game, such as the present level reached by users A, B, C and/or D. As a further alternative or in addition, the request may specify a maximum number of users to invite. Link server 210 creates, sets up and configures the requested links accordingly, wherein data available to the link server 210 is evaluated for users who satisfy the requested properties. If more than the maximum number of users are identified, the link server 210 may select invitees that satisfy the properties better than others. As an example, users who are found to have played the game more recently than others may be included as invitees, whereas others may be discarded.

Subsequently, the link is sent over the Internet to client device 220 where it is provided to the invitees, such as over any medium that allows sharing. In one embodiment, the links may be provided via a social networking platform. The embodiment therefore allows inviting unknown users to connect. An invited user may see the link and accept the link by activating it. This will establish a connection to the game and allow the invitee to participate.

A further embodiment comprises an advertisement in place of the interactive session. In this embodiment, the link server 210 may be configured to include information about the advertised entity such as a logo, corporate information, etc., when creating the link. Invitees may be specified in the request as users who satisfy any or all of a selected set of properties, such as whether they have interests related to an advertised product, in particular whether they have purchased the related product or a similar product in a predetermined period of time. Invited users are provided with the link according to any means or steps mentioned in this disclosure. If an invited user activates the link, he will be enabled to watch the advertisement, such as a video advertisement. In one embodiment, invited users may receive points for watching the advertisement. Similar to embodiments described above, the advertisement may provide slots in order to restrict viewing the advertisement to a number of users.

Although the present disclosure and its advantages have been described in detail, it should be understood that various changes, substitutions and alterations can be made therein without departing from the spirit and scope of the disclosure as defined by the appended claims.

The embodiments of the invention in which an exclusive property or privilege is claimed are defined as follows:

1. A method for inviting users to participate in an interactive session, comprising:
receiving a request from a client device, said request specifying information regarding one or more invitees;
creating a link from said information regarding one or more invitees;
providing the link to said one or more invitees; and
in response to an invitee activating the link, establishing a connection to the interactive session and enabling said invitee to participate in said interactive session.

2. The method of claim 1, wherein the request further includes information regarding a present state of the interactive session, wherein creating a link includes using said information regarding a present state of the interactive session to provide details of the present state in the link when viewed by a user.

3. The method of claim 1, wherein the interactive session is provided within a social network that the one or more invitees are not a member of.

4. The method of claim 1, wherein creating the link includes determining the one or more invitees from the information regarding the one or more invitees, wherein the information includes attributes to be satisfied by users in order to be invited.

5. The method of claim 1, wherein providing the link to said one or more invitees comprises providing the link through email, SMS, a social network site, a website, or a forum.

6. The method of claim 1, wherein the link is created and provided by a link server.

7. The method of claim 1, wherein the interactive session is an interactive multiplayer game.

8. The method of claim 1, wherein the interactive session provides streaming media, in particular streaming audio and/or streaming video.

9. The method of claim 8, wherein the interactive session comprises one or more slots for participants that limit the number of participants.

10. The method of claim 1, wherein enabling said invitee to participate in the interactive session comprises providing access to additional functionality provided by a provider of the interactive session.

11. The method of claim 10, wherein the interactive session is provided from within a social network and wherein enabling said invitee to participate in the interactive session includes enabling the invitee to access functionality of the social network which is available to members of the social network only.

12. The method claim 1, further comprising creating a guest account for said invitee in response to the invitee activating the link.

13. A system for inviting users to participate in an interactive session, comprising:
a first server device providing an interactive session and adapted to create a request for a link into said interactive session; and
a second server device adapted to receive the request along with information regarding one or more invitees, and further adapted to create the link from said information regarding one or more invitees and to provide the link to said one or more invitees connected to the second server device via a network;
wherein the second server device is further adapted to establish a connection to the interactive session in its present state and to enable an invitee to participate in the interactive session in response to the invitee activating the link.

14. The system of claim 13, wherein the first server device is a social network server and wherein the one or more invitees are not a member of a social network provided by the social network server.

15. The system of claim 13, wherein the second server device is further adapted to provide the link through email, SMS, a social network site, a website, or a forum.

16. The system of claim 13, wherein the interactive session is an interactive multiplayer game.

17. The system of claim 13, wherein the interactive session provides streaming media, in particular streaming audio and/or streaming video.

18. The system of claim 13, wherein the interactive session comprises one or more slots for participants that limit the number of participants.

19. A link server device, comprising:
a receiver adapted to receive a request along with information regarding one or more invitees for an interactive session;
a first processing module adapted to create a link from said information regarding one or more invitees and to provide the link to said one or more invitees connected to the link server device via a network; and
a second processing module adapted to establish a connection to the interactive session and to enable an invitee to participate in the interactive session in response to the invitee activating the link.
